(19) United States
(12) Patent Application Publication
(10) Pub. No.: US 2005/0160071 A1
(43) Pub. Date: Jul. 21, 2005

(54) Electronic apparatus

(76) Inventor: Naoki Ura, Tokyo (JP)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 11/038,685

(22) Filed: Jan. 19, 2005

(30) Foreign Application Priority Data
Jan. 21, 2004 (JP) P2004-012979

(51) Int. Cl. G06F 7/00

(52) U.S. Cl. 707/1

(57) ABSTRACT

An electronic apparatus enables to read and write HTML files from and into a storage portion, and is connected to a computer through a communication network. The electronic apparatus has a data collection and process portion that collects data obtained from an external process, reads an original HTML file from the storage portion, incorporates the collected data into the original HTML file to produce a new HTML file, and writes the new HTML file into the storage portion; and a communication portion that transmits the new HTML file stored in the storage portion to the computer.

### BACKGROUND OF THE INVENTION

1. Field of the Invention

The invention relates to an electronic apparatus such as a programmable controller which operates and monitors an apparatus disposed in various industrial processes, a production line in a factory, various experimental facilities, or the like, an adjustment apparatus, a data collection apparatus which collects various data, a recorder, and an oscilloscope. The invention especially relates to the electronic apparatus connected to a computer through a communication network to transmit and receive various instructions and data.

2. Description of the Related Art

The following documents relate to an electronic apparatus system configured by various electronic apparatuses and a computer connected to the electronic apparatuses through a communication network to transmit and receive instructions and data.

JP-T-2002-503410 and U.S. Pat. No. 5,805,442 are referred to as related art.

FIG. 3 is a block diagram schematically showing an example of a conventional electronic apparatus system.

Referring to FIG. 3, an electronic apparatus 10 which operates and monitors an apparatus disposed in various industrial processes, a production line in a factory, various experimental facilities, or the like has a control portion 11 having a controlling function, a data collection and process portion 12 which transmits and receives various data to and from the control portion 11 and a process P, and a web server 13 which processes input/output data related to the data collection and process portion 12.

The control portion 11 is a block which is a nucleus portion of the electronic apparatus 10, and which processes, coverts, and treats data supplied from the data collection and process portion 12. In accordance with the configuration of the control portion 11, the electronic apparatus 10 can function as either of a programmable controller, an adjustment apparatus, a data collection apparatus, a recorder, an oscilloscope, or like apparatuses.

The data collection and process portion 12 is a software block which captures historical data from a storage portion 20 described later, and which gives and receives realtime data from and to the control portion 11 in a constant cycle.

The web server 13 is a block having a usual web server function which is popularly used in a server, and captures data from the data collection and process portion 12. As described later, the web server is a block including a software program component such as an applet based on JAVA (registered trademark, an object-oriented programming language which is a product of Sun Microsystems, Inc.) which is downloaded to the client side to be implemented.

The electronic apparatus 10 further has the storage portion 20. The storage portion 20 stores an HTML (Hyper Text Markup Language) file 21, and transmits it to the web server 13.

The HTML file 21 is a file defining a display form on a display device of a client (a computer 30 connected to a network L) described later.

The communication network L is a public telephone communication line, a LAN (Local Area Network), an Internet communication line, an Intranet communication line, a WAN (Wide Area Network), a wireless communication line, or the like.

The computer 30 is a client computer such as a personal computer which is to be connected to the communication network L, and which has a usual configuration. Namely, the computer is a personal computer (PC) which has a browser 31, and which is placed on the side of the user.

The above electronic apparatus system operates in the following manner.

When monitoring of the process P is to be started, the user first transmits an HTML download request from the browser 31 of the computer 30 to the web server 13 in the electronic apparatus 10 through the communication network L.

As a result, the web server 13 extracts the HTML file 21 stored in the storage portion 20.

When data to be embedded in the acquired HTML file 21 are required, then, data of the process P are read out by the data collection and process portion 12 performing the background function, and the web server 13 acquires the data.

Next, the web server 13 embeds the data of the process P in the HTML file 21, and transmits the resulting file as a reply to the computer 30 through the communication network L.

As a result of this function, with using usual browser software, the user of the computer 30 can monitor various data of the process P, i.e., data handled in a process such as an industrial process, a production line, and various experimental facilities, in a display form of a web page through the communication network L.

Although the example in which only one electronic apparatus 10 is connected to the communication network L is shown in FIG. 3, a plurality of such electronic apparatuses may be connected to the network.

As a specific example, a case where the electronic apparatus 10 has the control portion 11 having a function of measuring the temperature will be considered. In response to instructions from the browser 31 of the computer 30, temperature data of the process P which are collected by the data collection and process portion 12 are transmitted together with a thermometer graphic which is set in the web server 13, to the computer 30 through the communication network L.

Then, the browser 31 receives such various instructions and actual data and displays the thermometer graphic indicating the temperature data, so that the computer 30 connected to the communication network L can know the present status of the process P via an ordinary web page.

However, the above electronic apparatus system has the following problem.

In many cases, a large number of computer 30 are disposed as clients on the communication network L. When one electronic apparatus 10 is simultaneously accessed by many computers, the electronic apparatus 10 must collect data of the process P at this timing. Therefore, the load of the electronic apparatus 10 is rapidly increased, so that smooth operation of the system cannot be sometimes realized.

### SUMMARY OF THE INVENTION

The object of the invention is to reduce the load of an electronic apparatus, and to improve the efficiency of the operation of the whole system.

The invention provides an electronic apparatus enabling to read and write HTML files from and into a storage portion, and connected to a computer through a communication network, having: a data collection and process portion that collects data obtained from an external process, reads an original HTML file from the storage portion, incorporates the collected data into the original HTML file to produce a new HTML file, and writes the new HTML file into the storage portion; and a communication portion that transmits the new HTML file stored in the storage portion to the computer.

Furthermore, the data collection and process portion writes the new HTML file, as a file which is different from the original HTML file, into the storage portion.

Furthermore, the data collection and process portion performs the process of producing the new HTML file by a background process.

Furthermore, the data collection and process portion performs the process of producing the new HTML file in a constant cycle.

Furthermore, the HTML files involve a specific tag, and the data collection and process portion refers to a specific tag in the original HTML file, and rewrites data corresponding to the specific tag.

Furthermore, the communication portion transmits the new HTML file to the computer base on an FTP protocol.

Furthermore, a filename extension recognized as a HTML file by the computer is given to the new HTML file.

The electronic apparatus uses not HTTP protocol but FTP protocol as a communication system. Further, the electronic apparatus collects data, and produces an HTML file into which the process data are incorporated, in a background process. Therefore, even when the electronic apparatus is simultaneously accessed by many computers, the electronic apparatus is not required to collect data of the process at this timing. In this case, since the electronic apparatus transmits the HTML file which is already produced, the load of the electronic apparatus is not rapidly increased, so that smooth operation of the system can be realized.

### BRIEF DESCRIPTION OF THE DRAWINGS

FIG. 1 is a block diagram showing the configuration of an embodiment of the invention;

FIG. 2 is a flowchart showing the operation of the embodiment; and

FIG. 3 is a block diagram showing the configuration of a conventional electronic apparatus system.

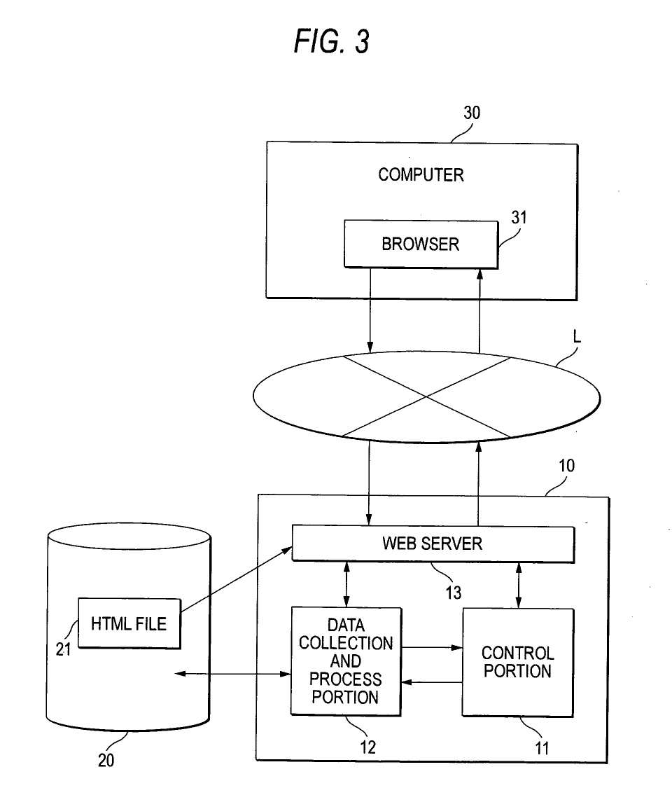

### DETAILED DESCRIPTION OF THE PREFERRED EMBODIMENTS

An embodiment of the invention will be described in detail with reference to the drawings.

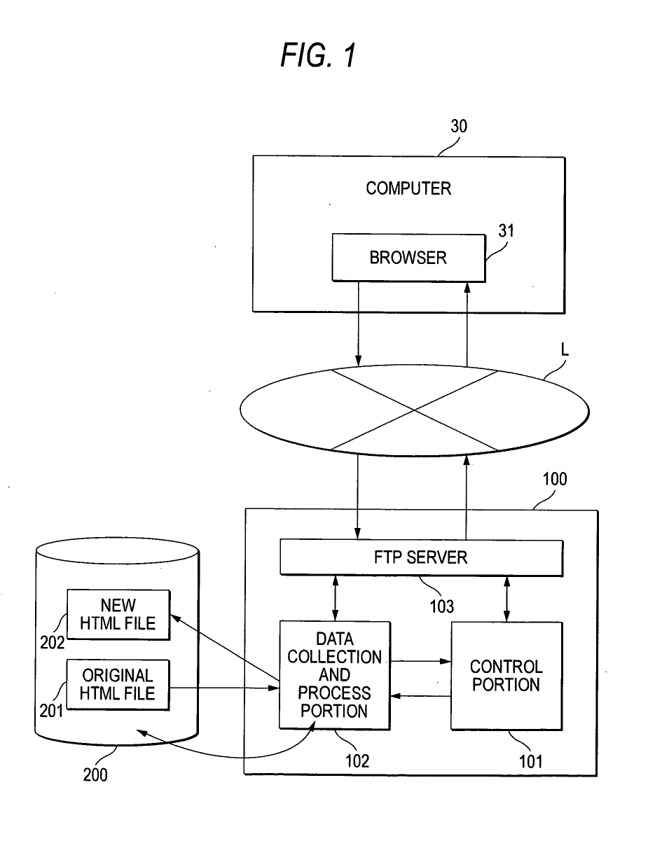

FIG. 1 is a block diagram showing the configuration of an embodiment of the invention.

FIG. 1 shows an electronic apparatus system in which an electronic apparatus 100 and a computer 30 are connected to a communication network L. In the embodiment, the electronic apparatus 100 has a storage portion 200.

The electronic apparatus 100 is an apparatus which is connected to the communication network L through an FTP server 103 (FTP: File Transfer Protocol), and which operates, monitors, and controls an apparatus disposed in a process P such as an industrial process or a production line, and collects data therefrom, such as a programmable controller, a controller, a data collection apparatus, an oscilloscope, and a recorder. The electronic apparatus 100 has a control portion 101 which is a nucleus portion of the electronic apparatus 100, and a data collection and process portion 102.

The data collection and process portion 102 is a software block which captures historical data from the storage portion 200, and which performs gives and receives realtime data from and to the control portion 101 in a constant cycle.

Moreover, the data collection and process portion 102 reads an original HTML file 201 which is previously stored in the storage portion 200, and acquires data which have been once transmitted to the control portion 101 to be processed, from the control portion 101. The data collection and process portion 102 then produces a new HTML file 202 as a different file from the original HTML file 201. The new HTML file 292 is stored into the storage portion 200.

As described above, the data collection and process portion 102 reads the original HTML file 201 including a specific tag, obtains process data of a process tag contained in the specific tag from the control portion 101, and produces the new HTML file 202, in a constant cycle.

Unlike the related art in which HTTP (Hyper Text Transfer Protocol) is used, a browser 31 of the computer 30 connected to the communication network L obtains the new HTML file 202 based on FTP by accessing the FTP server 103 disposed in the electronic apparatus 100.

In accordance with the acquired new HTML file 202, the browser 31 adequately displays the data in a required format.

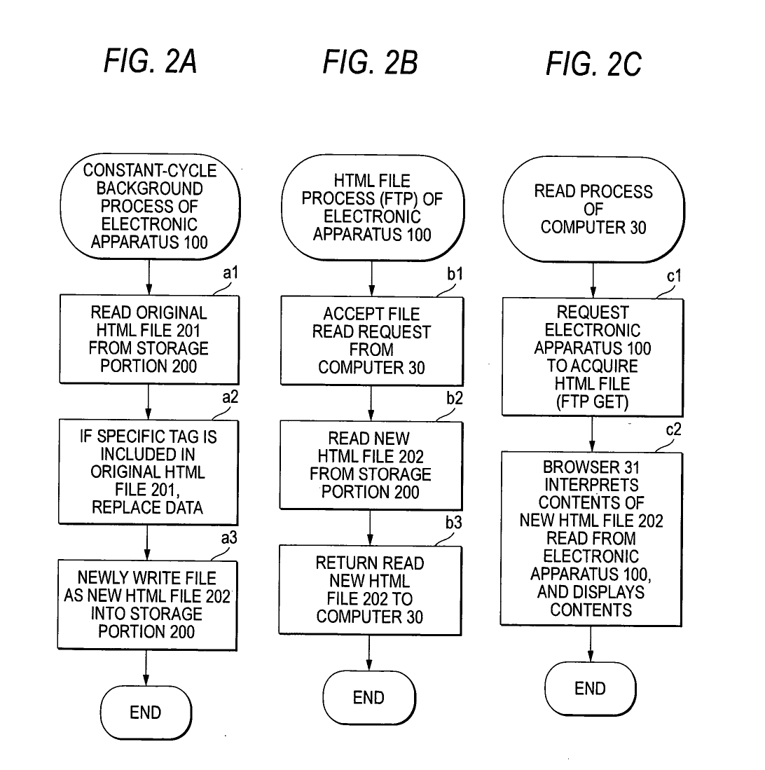

Next, the operation of the electronic apparatus system will be described in detail with reference to the flowchart of FIG. 2.

FIG. 2A shows the background process of the electronic apparatus 100 performed in a constant-cycle, FIG. 2B shows an HTML file process (FTP) which is performed with the storage portion 200 by the electronic apparatus 100, and FIG. 2C shows a read process which is required to the electronic apparatus 100 by the computer 30.

In step a1 of FIG. 2A, the data collection and process portion 102 of the electronic apparatus 100 periodically reads the original HTML file 201 from the storage portion 200 while collecting data from the process P and transferring the data to the control portion 101.

In step a2 of FIG. 2A, if a specific tag is included in the original HTML file 201, the data collection and process portion 102 refers to the control portion 101 and newly rewrites data corresponding to the specific tag.

In step a3 of FIG. 2A, the data collection and process portion 102 writes the file in which the data newly rewritten, into the storage portion 200 as the new HTML file 202.

In the above, the constant-cycle background process of the electronic apparatus 100 has been described.

In step b1 of FIG. 2B, the electronic apparatus 100 accepts an access request (file read request) from the computer 30.

In step b2 of FIG. 2B, in response to the access request, the data collection and process portion 102 reads the new HTML file 202 from the storage portion 200, and transmits the file to the FTP server 103.

In step b3 of FIG. 2B, the FTP server 103 transmits the new HTML file 202 as a reply to the computer 30 through the communication network L.

In the above, the process in the case where the electronic apparatus 100 is accessed by the computer 30 has been described.

In step c1 of FIG. 2C, an HTML file request (FTP GET) is transmitted by the user from the computer 30 to the electronic apparatus 100.

In step c2 of FIG. 2C, the browser 31 interprets the contents of the new HTML file 202 sent from the electronic apparatus 100, and adequately displays the contents on a display device.

At the timing when, in step c1 of FIG. 2C, the electronic apparatus 100 is requested to transmit an HTML file, the HTML file process of FIG. 2B which is performed on the storage portion 200 by the electronic apparatus 100 is activated. At the timing when this process is ended, step c2 of FIG. 2C is implemented.

In the embodiment, the computer 30 obtains an HTML file by means of FTP in place of HTTP, and recognizes the file as an HTML file by checking the filename extension of the file.

Then, the process status can be known in the form of a web page on the computer 30.

1. An electronic apparatus enabling to read and write HTML files from and into a storage portion, and connected to a computer through a communication network, comprising:
a data collection and process portion that collects data obtained from an external process, reads an original HTML file from the storage portion, incorporates the collected data into the original HTML file to produce a new HTML file, and writes the new HTML file into the storage portion; and
a communication portion that transmits the new HTML file stored in the storage portion to the computer.

2. The electronic apparatus according to claim 1,
wherein the data collection and process portion writes the new HTML file, as a file which is different from the original HTML file, into the storage portion.

3. The electronic apparatus according to claim 1,
wherein the data collection and process portion performs the process of producing the new HTML file by a background process.

4. The electronic apparatus according to claim 3,
wherein the data collection and process portion performs the process of producing the new HTML file in a constant cycle.

5. The electronic apparatus according to claim 1,
wherein the HTML files involve a specific tag, and
the data collection and process portion refers to a specific tag in the original HTML file, and rewrites data corresponding to the specific tag.

6. The electronic apparatus according to claim 1,
wherein the communication portion transmits the new HTML file to the computer base on an FTP protocol.

7. The electronic apparatus according to claim 1,
wherein a filename extension recognized as a HTML file by the computer is given to the new HTML file.
